(19) United States
(12) Patent Application Publication
(10) Pub. No.: US 2024/0362525 A1
(43) Pub. Date: Oct. 31, 2024

(54) SERVERLESS DATA-REPRESENTATION-AS-A-SERVICE (DRAAS) TO ENABLE BUILDING GENERAL MULTI-MODAL INPUT DATA ML FLOWS

(71) Applicant: Oracle International Corporation, Redwood Shores, CA (US)

(72) Inventors: Vesselin Diev, San Antonio, TX (US); Jean-Rene Gauthier, Temecula, CA (US)

(21) Appl. No.: 18/141,305

(22) Filed: Apr. 28, 2023

(51) Int. Cl. G06N 20/00

(52) U.S. Cl. CPC G06N 20/00

(57) ABSTRACT

Techniques for enabling the building of general input data ML flows using a serverless data-representation-as-a-service (DRaaS) are provided. In one technique, in response to receiving a first data representation (DR) generation request from a first calling entity, first input data is retrieved based on the first DR generation request, a first set of DRs is generated (by a DR generator) based on the first input data, and the first set of DRs are made available to the first calling entity. In response to receiving a second DR generation request from a second calling entity that is different than the first calling entity, second input data is retrieved based on the second DR generation request, a second set of DRs is generated based on the second input data, and the second set of DRs are made available to the second calling entity.

### BACKGROUND

When building a machine learning (ML) pipeline to solve, the available input data is often of different modality types. Input data modalities can be of different types, such as tabular, time series, text, image, video, documents, and audio. For example, in order to train a machine learning model to do product classification for an enterprise, the input data might consist of a product title and description in the text modality, images and/or video for the product, tabular attributes (e.g., Manufacturer Name, Brand Name, etc.), and documents, such as a Safety Data Sheet (needed for compliance), etc. How to build the most performant ML modeling pipeline for multi-modal data inputs is a hot research area in the data science community.

Currently, data scientists rely on significant manual coding and experimentation with different data representation techniques for each modality, trying early or late fusion ML models that combine those signals. This is a very time consuming process and often leads to models that are not the best performing.

Another large application of data representations is in single-modal input data setting where a downstream use case exists for object similarity, grouping, or ranking for the particular input data type. Performing a similarity image search given an input query image and identifying duplicate documents for a given seed document are two examples of a single-modal input data setting. If there was a system that generates data (e.g., vector) representations of the images or documents, then finding most similar images (or duplicate documents) is primarily a matter of applying a similarity function (e.g., cosine similarity) on top of those data representations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example of a general ML workflow;

FIG. 2 is a block diagram that depicts different input data modalities to a DRaaS service, in an embodiment;

FIG. 3 is a block diagram that depicts a general paradigm for solving any use case where multi-modal data inputs are present, in an embodiment;

FIG. 4 is a block diagram that depicts an example system that provides individual data type representations that enables single-modal use cases, in an embodiment;

FIG. 5 is a block diagram that depicts an example system for generating and providing a joint multi-modal representation, in an embodiment;

FIG. 6 is a flow diagram that depicts an example process for providing data representations as a service, in an embodiment;

FIG. 7 is a block diagram that illustrates a computer system upon which an embodiment of the invention may be implemented;

FIG. 8 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Currently, there are no tools, frameworks, libraries, or services that can provide automated data ingestion and “featurization/representation-as-a-service” for a given modality type that data scientists can readily leverage in their ML flows. In other words, there is no way to send a raw data object of any type to an online service and receive, in return, a meaningful vector representation of that raw data object. As more and more machine learning use cases require input data in multiple modalities, automated data ingestion and featurization is a critical gap in current open source tools and machine learning platforms.

A system and method for providing a cloud service that generates and provides data representations of input data objects are described. In one technique, a user initiates and sends a client data representation (DR) generation request (that is associated with one or more data objects) to the cloud service, the cloud service generates a data representation (e.g., a vector or an embedding) for each data object, and returns the generated data representation(s) to the user as a response to the DR generation request. In this way, data scientists do not need to spend time in feature engineering or developing and training DR generators (or the models upon which the DR generators are based). Also, embodiments effectively lower the skill level required to generate and maintain ML workflows that operate on data representations of data objects. Furthermore, the cloud service may offer better quality compared to other approaches.

Therefore, embodiments improve computer-related technology by providing a DRaaS (data representation-as-a-service) service for various input modalities, which service can be easily leveraged in ML workflows of various configurations. Thus, instead of providing Al Service APIs that take raw data input and return a prediction for a pre-defined use case, embodiments involve a serverless architecture where data representations are returned to the client. The client then has the flexibility to use these data representations in downstream ML flows and customize for specific use cases.

Embodiments described herein represent a significant departure from existing Al services paradigms, which provide predictions for a select number of pre-defined use cases, and do not allow for flexibility or customization of (1) what is being predicted or (2) tuning the featurization and an ensemble model process. For example, cloud providers, as part of their ML/AI offering, offer a collection of Al services that include pre-built, optimized ML models on a single input data modality and are focused on a narrow range of use cases for that input data modality, such as sentiment classification for input text, object detection for input images, and anomaly detection for input time series telemetry data. Having a DRaaS service provide data representations of customer reviews (input data modality of text), for example, allows data scientists to quickly customize for a fake review detection use case. In contrast, current language Al services as built can only be used for general use cases, such as sentiment analysis of the customer reviews, text classification, keyword detection, language detection, named entity recognition, and personal identifying information (PII) detection. Current language Al services are not built to answer a specific use case, such as product classification. Therefore, an ML practitioner needs to further develop on top of these outcomes to tailor and solve for a specific use case.

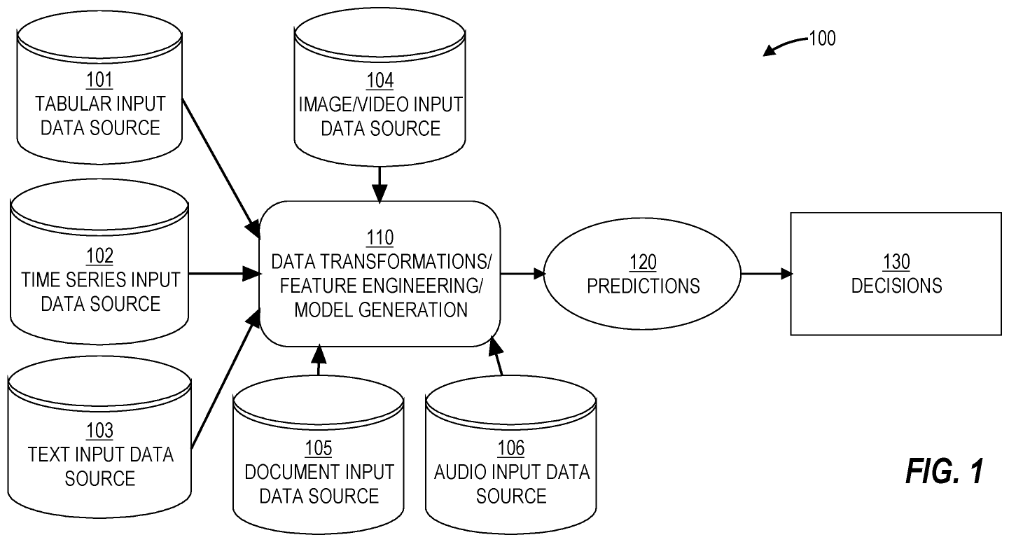

Many real world use cases typically need multiple input data modalities that need to be intelligently featurized and fused in downstream ML models in order to achieve high performance (see FIG. 1). This is different from a mixture of experts which are typically trained on each modality separately and have their predictions combined using some majority voting or other aggregation logic. Embodiments provide individual data modality data representations (not predictions) and, optionally, a joint representation across all modalities. In principle, such embodiments have the potential to yield superior performance over models that have only seen a subset of the predictive features and generate predictions only on those.

### General ML Workflow

FIG. 1 is a block diagram that depicts an example of a general ML workflow 100. Workflow 100 comprises multiple input data sources 101-106, each corresponding to a different data modality or type. Input data sources 101-106 include tabular data, time series data, text data, image/video data, document data, and audio data. The first two modality types are structured data while the latter four modality types are unstructured.

Workflow 100 also comprises a block 110 that represents the majority of the work and effort, which is producing data transformations, performing feature engineering, and generating and training one or more ML models. Output from the ML models of block 110 are predictions 120, which lead to decisions 130, such as deduplication, grouping, recommending, etc.

Block 110 represents an opportunity for ML practitioners to leverage vector representations provided by a DRaaS service. With a DRaaS service, ML practitioners only need to work on generating and training one or more downstream ML models. The DRaaS service represents a general paradigm/pattern for building a custom ML pipeline, on any platform, and solves for any use case for any available data input modalities.

### DRAAS Service

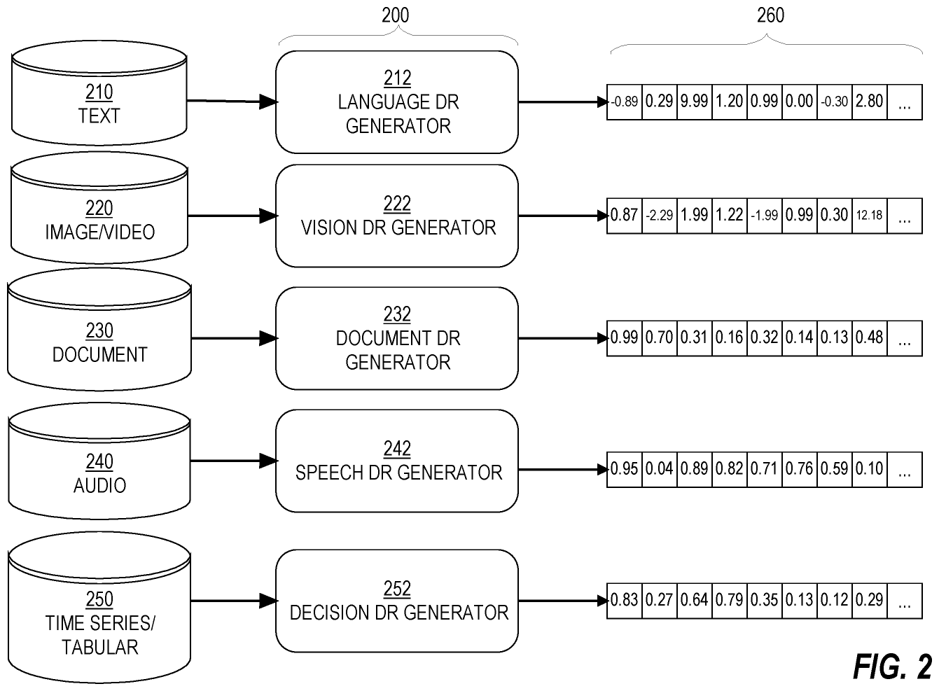

On any given input data modality, a DRaaS service is called, generates data representations (vector/matrix format) based on the input data that the DRaaS service ingests (see FIG. 2), and provides those data representations to the calling entity (or to a destination storage location specified in the call or by the caller). The DRaaS service may be called via an API, a software development kit (SDK), or an operator from a data science platform. The DRaaS service may be implemented in software, hardware, or a combination of software and hardware. The DRaaS service may be hosted on any cloud platform.

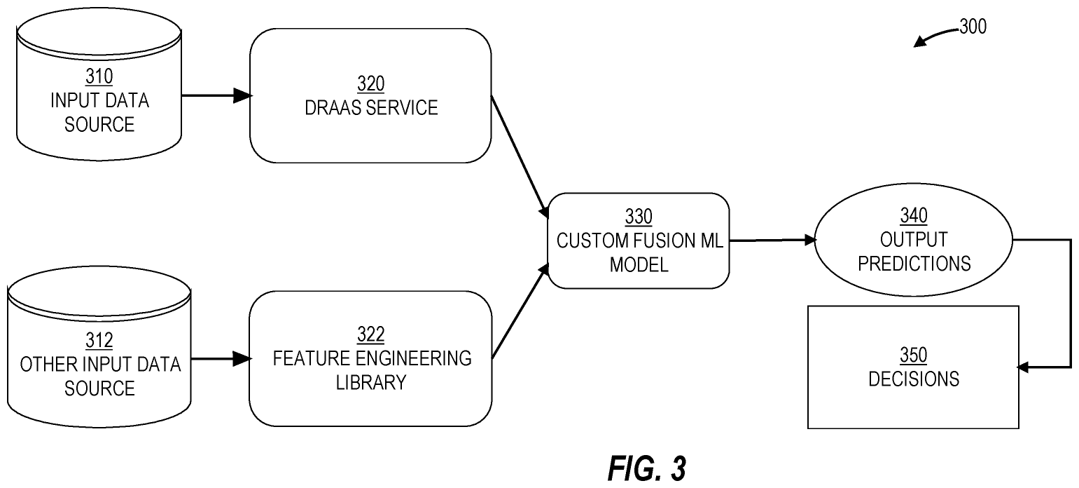

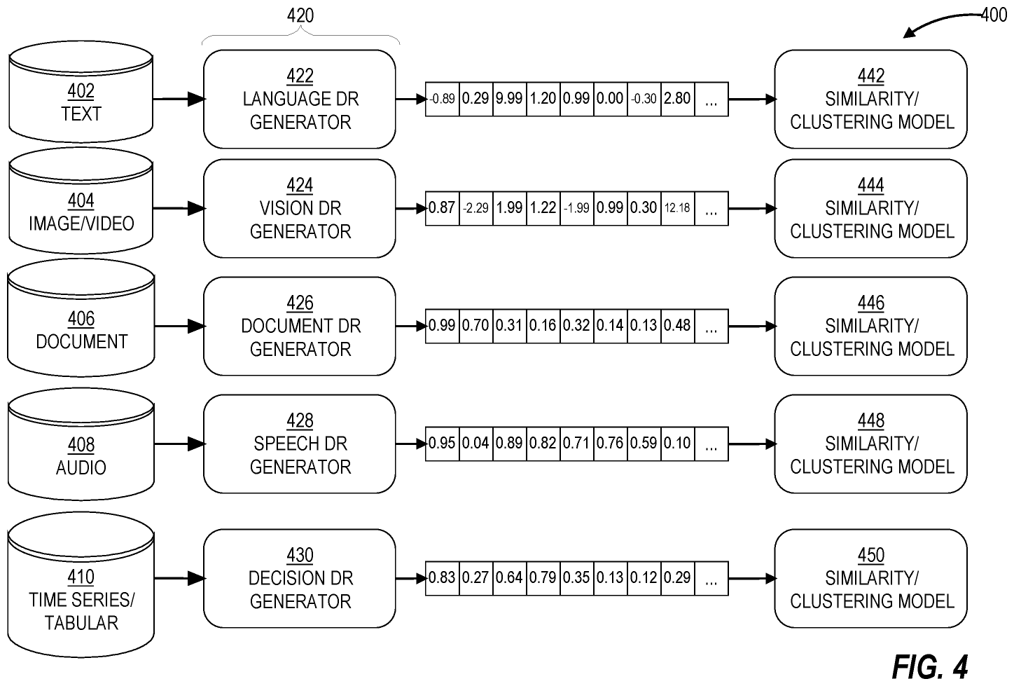

Each data representation of each data object of an input data modality type is represented as a numerical vector, which is available as is for further custom fusion algorithms to ingest in a general ML flow (see FIG. 3). Alternatively, numerical vectors can be used in single-modal data use cases (e.g., for similarity search/ranking/grouping), where such functions/models are to be applied (see FIG. 4).

FIG. 2 is a block diagram that depicts different input data modalities to a DRaaS service 200, in an embodiment. In an embodiment, DRaaS service 200 includes a data representation (DR) generator for each of multiple input data modalities. In the depicted example, the input data modalities include text 210, image/video 220, document 230, audio 240, and time series or tabular 250. The DRaaS service includes a language DR generator 212, a vision DR generator 222, a document Al DR generator 232, a speech DR generator 242, decision DR generator 252. Although FIG. 2 depicts a single DR generator for time series input data and tabular input data (which are two different types of input data modalities), there may be a separate DR generator for each. The output of the DR generators are data representations 260.

While FIG. 2 depicts each generated/output data representation as a single dimension vector of values, one or more of the DR generators may output an N×M matrix of values. A DR generator takes in input (e.g., text string, a document, a two-dimensional image, time series data, an audio file) and may transform the input into a form that is acceptable to a model that the DR generator comprises. The model may be a trained neural network that takes transformed input and produces output (e.g., a vector or matrix of values) of a certain size.

The model of each DR generator may be trained on a large corpus of general data. For example, a model for vision DR generator 222 may be trained to recognize hundreds of different types of objects, from man-made objects to objects found in nature. As another example, a model for language DR generator 212 may be trained to recognize many types of sentiment reflected in textual data found in customer reviews. Alternatively, the models of some DR generators may be trained on vertical data sets. For example, there may be two DR services for documents: one that is specialized for clinical notes and another that is specialized for legal documents (e.g., contracts).

Data representations may be unsupervised or supervised depending on whether labels were available to DRaaS service 200. For example, some DR generators (or models of DR generators) of DRaaS service 200 may have been trained using an unsupervised machine learning technique while some DR generators of DRaaS service 200 may have been trained using a supervised machine learning technique. Examples of supervised machine learning techniques include decision tree, logistic regression, linear regression, and support vector machines. Examples of unsupervised machine learning techniques include K-means clustering, principal component analysis, hierarchical clustering, and various deep learning autoencoder architectures.

In an embodiment, DRaaS service 200 includes multiple calling endpoints, each endpoint corresponding to a different input data modality type. For example, if calling entities desire to use a language DR generator of DRaaS service 200, then the calling entities send DR generation requests to a first endpoint corresponding to the language DR generator. If calling entities desire to use a speech DR generator of DRaaS service 200, then the calling entities send DR generation requests to a second endpoint corresponding to the speech DR generator.

### General Paradigm

FIG. 3 is a block diagram that depicts a general paradigm 300 for solving any use case where multi-modal data inputs are present, in an embodiment. Paradigm 300 may represent a specific embodiment that includes an input data modality 310, a DRaaS service 320, other input data 312, a feature engineering library 322, a custom fusion ML model 330, output predictions 340, and decisions 350. In general paradigm 300, DRaaS service 320 generates and provides data representations, which enables downstream custom fusion models in multi-modal data scenarios. A “fusion” model is one that accepts data representations as input that are from different data sources.

For example, input data modality 310 may be text, and other input data 312 may be video. Thus, DRaaS service 320 may generate data representations for only a single modality type (e.g., only text). Alternatively, DRaaS service 320 may generate data representations for multiple modalities (e.g., text and video). Feature engineering library 322 includes routines for a ML data scientist to call in his/her code in order to generate feature values, from other input data 312, for multiple features upon which custom fusion ML model 330 is based.

While DRaaS service 320 has a line connecting DRaaS service 320 with custom fusion ML model 330, this does not necessarily mean that DRaaS service 320 communicates with custom fusion ML model 330. Instead, the output from DRaaS service 320 is input to custom fusion ML model 330.

Because the model of DRaaS service 320 has not been trained in conjunction with the training of custom fusion ML model 330, the accuracy of data representations that DRaaS service 320 generates might be relatively low. However, any such “lost ground” may be made up in the training of custom fusion ML model 330 based on those data representations.

### Single Use Cases

FIG. 4 is a block diagram that depicts an example system 400 that provides individual data type representations that enables single-modal use cases, in an embodiment. System 400 includes input data sources 402-410, DRaaS service 420, and DR generators 422-430 that are part of (e.g., components or sub-services of) DRaaS service 420. Each DR generator corresponds to a different input data modality, such as text and images. Specifically, text input 402 is processed by a language DR generator 422, image/video input 404 is processed by a vision DR generator 424, document input 406 is processed by document Al DR generator 426, audio input 408 is processed by speech DR generator 428, and time series/tabular input 410 is processed by decision DR generator 430. Each generator generates a data representation, such as a vector of size N or a matrix of size N×M. Different generators may generate data representations of different sizes.

Such output data representations are then consumed, respectively, by one of trained similarity/clustering ML models 442-450. Each of similarity/clustering ML models 442-450 may operate differently. For example, ML model 442 may be a text similarity ML model that, given two data representations as input, generates output that indicates whether the data objects (e.g., two text strings) represented by the two data representations are similar. As another example, ML model 444 may be a clustering ML model that takes many (e.g., a batch of) data representations as input and outputs one or more clusters (or groups) of data representations, each cluster representing a set of data representations (e.g., of images) that ML model 444 predicts are similar enough to each other that the set of data representations should be clustered or grouped together and treated as distinct from other clusters. As currently represented in FIG. 4, similarity/clustering is done separately on each DR output. However, in principle, the similarity/cluster computation may be done across modalities if more than one modality is present in a request from an entity.

The output of each similarly ML model is an indication of whether two data objects are similar (whose data representations were input to the similarity ML model) and the output of each clustering ML model is a set of one or more clusters, each cluster including references to one or more data objects whose data representations were input to the clustering ML model.

### Joint Multi-Modal Representation

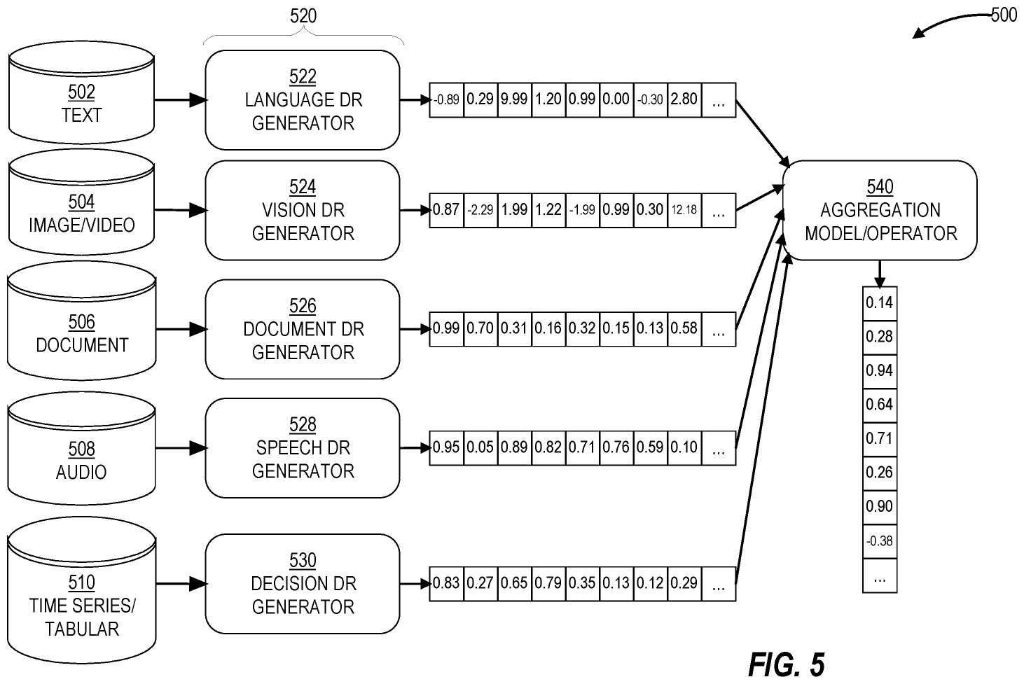

In an embodiment, a DRaaS system generates multiple data representations of different modalities and aggregates those data representations into a single joint multi-modal representation. FIG. 5 is a block diagram that depicts an example system 500 for generating and providing a joint multi-modal representation, in an embodiment. System 500 includes input data sources 502-510, DRaaS service 520, DR generators 522-530 that are part of (e.g., components or sub-services of) DRaaS service 520, and an aggregation model/operator 540, which is also part of DRaaS service 520. (Aggregation model/operator 540 may be similarity/clustering output.) Thus, system 500 is similar to system 400 except that multiple data representations that are generated by two or more of DR generators 522-530 are aggregated or combined in some way to generate a single data representation.

The type of aggregation might depend on one or more downstream task outcomes, such as product classification, user recommendation, or fraud detection. Then, a ML practitioner works backwards from those outcomes (labels) to tune the aggregation of the different modality types. “Tuning the aggregation” means improving the overall quality of the joint data representation via providing fine outcome labels and re-training the model.

If aggregation model/operator 540 is an operator, then example operations include concatenation, mean, median, min, max, percentile. For example, if two single modal data representations are of length N and M, respectively, and the operation is concatenation, then the length of a joint data representation is length N+M. As another example, if three single modal data representations are of length N and the operation is mean, then the length of a joint data representation is length N.

If aggregation model/operator 540 is a model, then the model may output a joint data representation that is larger, smaller, or the same size as individual input data representations. For example, the model may be a neural network with one or more hidden layers. The model has been trained based on outputs from data generators 522-530.

The output of aggregation model/operator 540 may be used by a ML model that is downstream relative to DRaaS service 520, that is developed by a ML practitioner (and customer of DRaaS service 520), and that has been trained by outputs from aggregation model/operator 540.

### Calling a DRAAS Service

A computing (calling) entity (e.g., a process, a program, a cloud application, a computing device executing code) may call a DRaaS service in one of two main modes: a single input mode or a batch mode. In single input mode, the DRaaS service receives a single data object (e.g., a text string, a document, an image, an audio file, a video file) and generates a single data representation based thereon. A call to the DRaaS service may include the data object or a reference to a storage location where the data object is stored. The storage location may be remote or local relative to the DRaaS service. If remote, the storage location may be managed by a third-party storage service and the reference (or storage location identification data) may include credential data that allows the DRaaS service to access the storage location.

Once the DRaaS service generates a data representation, the DRaaS service may return the data representation to the computing entity that called the DRaaS service. Alternatively, the DRaaS service stores the data representation at a (local or remote) location associated with the calling computing entity, which location may be specified in the triggering call.

In batch mode, a DRaaS service receives a batch of multiple data objects in a single call or identifies multiple data objects in response to a single call (from a computing entity that requests data representations for data objects) and generates multiple data representations, one for each data object in the batch. A call to the DRaaS service may include a reference (or storage location identification data) to a first storage location where the batch of data objects are stored. The DRaaS service uses first storage location identification data (e.g., specified in the call) to retrieve the batch of data objects (e.g., one by one), generates a data representation for each data object in the batch, and stores the data representation at a second storage location using second storage location identification data (which may have also been specified in the call), which may be associated with the first storage location. The DRaaS service may inform the calling computing entity when all the requested data representations have been generated and are accessible to the calling computing entity, especially if the number of data objects in the batch are over a certain size or if the time to generate the data representations exceed a threshold amount of time.

For each data representation that a DRaaS service generates, the DRaaS service may also generate data representation (DR) identification data that uniquely identifies the data representation relative to other data representations that the DRaaS service generates, whether universally or for the calling computing entity (or organization with which the calling computing entity is associated). For example, each data object (for which the DRaaS service generates a data representation) has a name and the DRaaS service appends one or more characters to that name. As a specific example, the characters that the DRaaS service appends are “_DR.” Additionally or alternatively, the DRaaS service appends a timestamp of when (a) the corresponding data representation is generated or (b) the request to generate one or more data representations was received.

In an embodiment, the calling entity (i.e., that sends a DR generation request to a DRaaS service) is part of a data science (DS) platform that is hosted on the same cloud on which a DRaaS service is hosted. The DS platform allows ML practitioners to generate ML workflows. An ML workflow comprises one or more operands and operators, one of which corresponds to a DRaaS service. Thus, the DRaaS service may be invoked as if it is an operator. An operand of such an operator is a single data object (e.g., an image, a document, or a video file), a batch of data objects (e.g., multiple text strings or multiple images), or a reference to whether the data object (or batch) is located. Another operator in a ML workflow may be a ML model that takes output of one or more other operators as input. When a series of operators is executed, and one of those operators corresponds to the DRaaS service, then at least a portion of the output of the DRaaS service may be input into a downstream operator in the series, such as a similarity operator, a clustering operator, a classification operator, etc.

### Customization of Embeddings

Because a user of a DRaaS service relies on the training of the data representation generator(s) of the DRaaS service to generate data representations based on input data objects, the training might not be optimal for the subject matter area of interest of the user. For example, an image DR generator of a DRaaS service may be trained to recognize mammals in digital images while a user of the DRaaS service needs to leverage the image DR generator when making decisions based on images of street signs. Therefore, the image DR generator might generate data representations that reflect the existence of mammals but not the existence of street signs.

In an embodiment, a DRaaS service (or a DR generator thereof) is customized for a specific user or organization. A DR generator may be customized by copying the model upon which the DR generator is based and updating or re-training the model using additional training data. For example, a user causes a customization request to be transmitted to a DRaaS service. The customization request may include training data or storage location identification data that identifies a storage location where the training data is stored. The training data comprises a set of training instances. Each training instance in the set includes a data object (e.g., text string, document, or image) and a label. If the DR generator is classifier, then the label is one of multiple values, each value corresponding to a different class. For example, if the DR generator is an image classifier, then the training instance comprises an image and a label that may indicate whether the image depicts a certain type of object.

The customization request may also indicate an input modality type (e.g., text, image, document, video, or audio) that corresponds to the DR generator. In this way, DRaaS service knows which DR generator (if there are multiple DR generators) to update or retrain. Thus, a customization request is fundamentally different than a DR generation request for one or more data representations.

In response to receiving a customization request, the DRaaS service accesses a set of training instances, creates a copy of the ML model corresponding to the indicated input modality type, and trains that copy based on the set of training instances, resulting in a trained copy. The DRaaS service stores an entity ID in association with the trained copy, the entity ID uniquely identifying the entity (e.g., user or organization) that requested the customization. Thereafter, the DRaaS service invokes the trained copy when it receives DR generation requests from that entity.

A DR generation request from an entity that is associated with a customized version of DR generator may include customization data that indicates whether the customized version of the DR generator should be leveraged or whether a non-customized version of the DR generator should be leveraged. For example, a DR generation request may include a value in a particular position of the DR generation request where the value indicates that a customized version of a DR generator is to be used. If an entity is associated with multiple customized versions of a DR generator, then the value may specify or indicate which customized version to use. If a DR generation request does not include a value in the particular position of the DR request, then a generic DR generator is used, even if the requesting entity is associated with one or more customized versions of the DR generator.

### Example Process

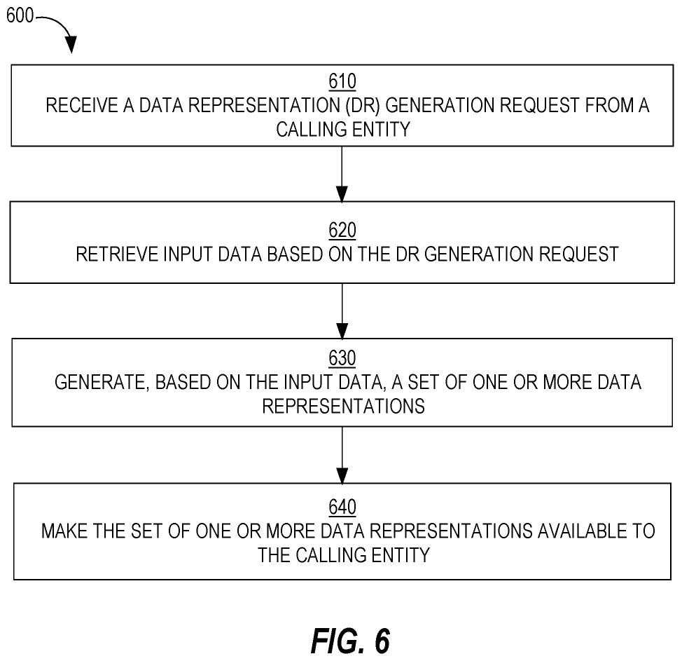

FIG. 6 is a flow diagram that depicts an example process 600 for providing data representations as a service, in an embodiment. Process 600 is implemented as a cloud service to any type of third-party calling entity. The calling entity is operated or instructed by an end user, which may be a representative of an organization. The end user may have an account with the cloud service, which account may require credentials (e.g., username and password) to access.

At block 610, a data representation (DR) generation request is received from a calling entity. The calling entity may be an entity executing on the same cloud platform as the cloud service. Alternatively, the calling entity may be executing on platform or device that is remote relative to the cloud service. For example, the DR generation request may be an HTTP request that is sent over one or more networks (including the Internet) to the cloud platform on which the cloud service is executing. The DR generation request may include input data that will be input to a DR generator of the cloud service or may include storage location identification data that identifies a storage location in which the input data is stored.

At block 620, input data is retrieved based on the DR generation request. Block 620 may involve the cloud service retrieving the input data from the DR generation request. Alternatively, if the DR generation request instead includes storage location identification data, then the cloud service uses the storage location identification data to retrieve the input data, such as by sending a (e.g., HTTP) request (e.g., to a third-party storage service) or making an API call that includes the storage location identification data or a portion thereof.

At block 630, a DR generator of the cloud service generates, based on the input data, a set of one or more data representations. If the input data is a single data object (e.g., an image file), then the DR generator generates a single data representation, such as a single dimension vector of values. If the input data comprises multiple data objects (e.g., multiple documents), then the DR generator generates a data representation for each of the multiple data objects.

Block 630 may first involve selecting a DR generator from among multiple DR generators, each DR generator corresponding to a different input modality type, such as text, document, image, video, and audio. Such selecting may involve determining an input modality type associated with the DR generation request and then matching that to one of the DR generators. Determining the input modality type associated with the DR generation request may involve identifying an input modality type indicator in the DR generation request or determining the input modality type of the input data.

At block 640, the set of one or more data representations are made available to the calling entity. Block 640 may involve sending a response to the calling entity that includes the set of one or more data representations. Alternatively, the response may include storage location identification data that identifies where the set of one or more data representations is stored. In this scenario, the calling entity uses the storage location identification data to retrieve the set of one or more data representations. Alternatively, the cloud service stores the set of one or more data representations in association with an account that is associated with the calling entity.

If the DR generation request includes only a single data object (or a reference to a single data object) and the calling entity requires data representations for multiple data objects, then the calling entity may generate a different DR generation request for each of the data objects. Thus, process 600 may be repeated with respect to the same calling entity but a different DR generation request and a different data object (and, thus, a different generated data representation).

Also, process 600 may be repeated but for different calling entities. The different calling entities may leverage the same DR generator (especially if the cloud service only includes a single DR generator) or different DR generators. Some DR generation requests may be considered “batch” requests (meaning each request includes or refers to multiple input data objects), whereas other DR generation requests (e.g., from other calling entities) may be considered “single” requests (meaning each request includes or refers to a single input data object).

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

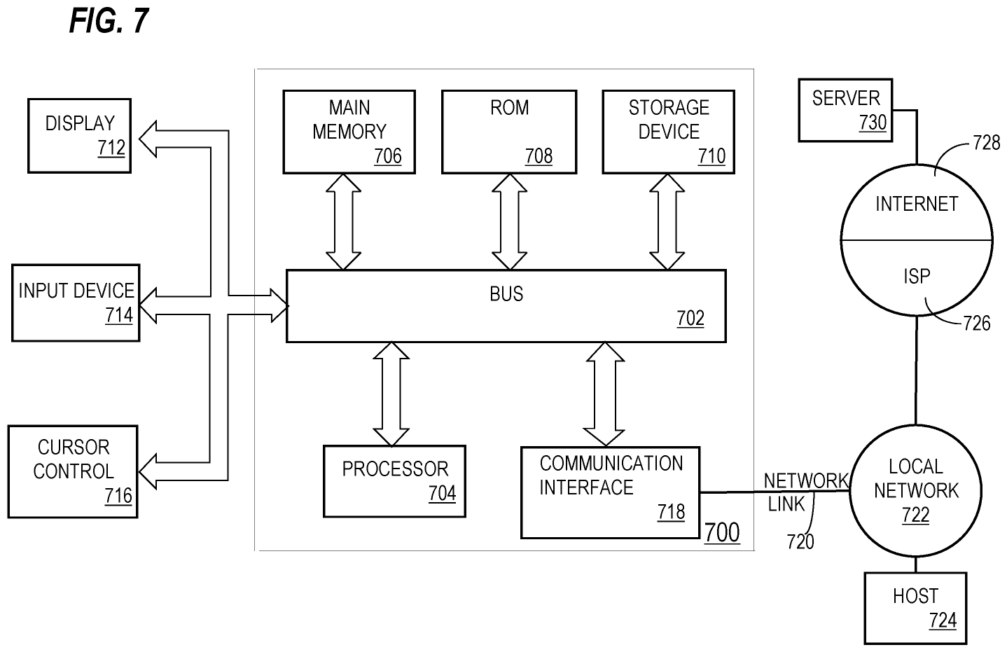

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic, or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Software Overview

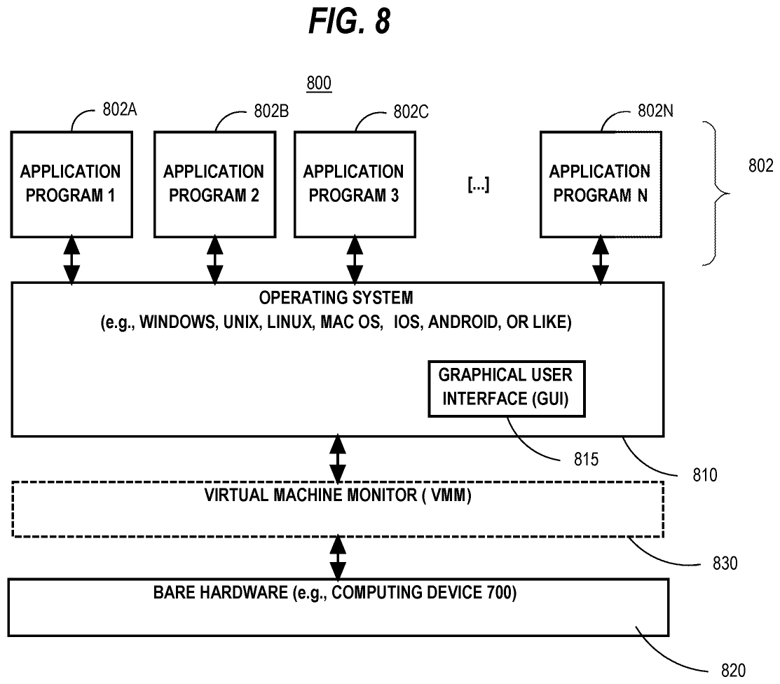

FIG. 8 is a block diagram of a basic software system 800 that may be employed for controlling the operation of computer system 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computer system 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on computer system 700 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of computer system 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the computer system 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of computer system 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
receiving a first data representation (DR) generation request from a first calling entity;
in response to receiving the first DR generation request:
retrieving first input data based on the first DR generation request;
generating, by a DR generator, based on the first input data, a first set of one or more data representations;
making the first set of one or more data representations available to the first calling entity;
receiving a second data representation (DR) generation request from a second calling entity that is different than the first calling entity;
in response to receiving the second DR generation request:
retrieving second input data based on the second DR generation request;
generating, by the DR generator, based on the second input data, a second set of one or more data representations;
making the second set of one or more data representations available to the second calling entity;
wherein the method is performed by one or more computing devices.

2. The method of claim 1, further comprising:
prior to generating the first set of one or more data representations, selecting the DR generator from among a plurality of DR generators, each corresponding to a different input modality type.

3. The method of claim 2, wherein the DR generator is a first DR generator that corresponds to a first input modality type, the method further comprising:
receiving a third data representation (DR) generation request from a third calling entity;
in response to receiving the third DR generation request:
retrieving third input data based on the third DR generation request;
generating, by a second DR generator that is different than the first DR generator and that corresponds to a second input modality type that is different than the first input modality type, based on the third input data, a third set of one or more data representations;
making the third set of one or more data representations available to the third calling entity.

4. The method of claim 2, wherein:
the plurality of DR generators correspond to a plurality of input modality types that include two or more modality types in a set consisting of text, document, image, video, audio, time series, and tabular;
the first input data is a text string, a document, an image file, a video file, an audio file, times series data, or tabular data.

5. The method of claim 1, wherein the first DR generation request includes an input modality type indicator that indicates a particular input modality type of the DR generator.

6. The method of claim 1, wherein:
the first DR generation request includes storage location identification data that indicates where the first input data is stored;
retrieving the first input data comprises using the storage location identification data to retrieve the first input data.

7. The method of claim 1, wherein making the first set of one or more data representations available comprises storing the first set of one or more data representations at a storage location that is accessible to the first calling entity.

8. The method of claim 7, wherein the first DR generation request includes storage location identification data that identifies the storage location.

9. The method of claim 1, further comprising:
receiving a customization request from a third calling entity;
in response to receiving the customization request, updating a model of the DR generator to generate a customized version of the model;
in response to receiving a third DR generation request from the third calling entity:
retrieving third input data based on the third DR generation request;
generating, using the customized version of the model of the DR generator, based on the third input data, a third set of one or more data representations;
making the third set of one or more data representations available to the third calling entity.

10. The method of claim 9, wherein:
the customization request includes storage location identification data that identifies a storage location where training data is stored;
the method further comprising retrieving the training data from the storage location;
wherein updating the model comprises re-training the model based on the training data.

11. The method of claim 9, further comprising:
in response to receiving the customization request, storing entity identification data that associates the customized version of the model with the third calling entity;
in response to receiving the third DR generation request, determining an identity of the third calling entity;
prior to generating the third set of one or more data representations, selecting the customized version based on the identity of the third calling entity.

12. A method comprising:
receiving a first data representation (DR) generation request from a first calling entity;
in response to receiving the first DR generation request:
retrieving first input data based on the first DR generation request;
selecting a first DR generator from among a plurality of DR generators, each corresponding to a different input modality type, wherein the first DR generator corresponds to a first input modality type;
generating, by the first DR generator, based on the first input data, a first set of one or more data representations;
making the first set of one or more data representations available to the first calling entity;
receiving a second data representation (DR) generation request from the first calling entity;
in response to receiving the second DR generation request:
retrieving second input data based on the second DR generation request;
selecting a second DR generator from among the plurality of DR generators, wherein the second DR generator corresponds to a second input modality type that is different than the first input modality type;
generating, by the second DR generator, based on the second input data, a second set of one or more data representations;
making the second set of one or more data representations available to the first calling entity;
wherein the method is performed by one or more computing devices.

13. One or more non-transitory storage media storing instructions which, when executed by one or more computing devices, cause:
receiving a first data representation (DR) generation request from a first calling entity;
in response to receiving the first DR generation request:
retrieving first input data based on the first DR generation request;
generating, by a DR generator, based on the first input data, a first set of one or more data representations;
making the first set of one or more data representations available to the first calling entity;
receiving a second data representation (DR) generation request from a second calling entity that is different than the first calling entity;
in response to receiving the second DR generation request:
retrieving second input data based on the second DR generation request;
generating, by the DR generator, based on the second input data, a second set of one or more data representations;
making the second set of one or more data representations available to the second calling entity.

14. The one or more storage media of claim 13, wherein the instructions, when executed by the one or more computing devices, further cause:
prior to generating the first set of one or more data representations, selecting the DR generator from among a plurality of DR generators, each corresponding to a different input modality type.

15. The one or more storage media of claim 14, wherein the DR generator is a first DR generator that corresponds to a first input modality type, wherein the instructions, when executed by the one or more computing devices, further cause:
receiving a third data representation (DR) generation request from a third calling entity;
in response to receiving the third DR generation request:
retrieving third input data based on the third DR generation request;
generating, by a second DR generator that is different than the first DR generator and that corresponds to a second input modality type that is different than the first input modality type, based on the third input data, a third set of one or more data representations;
making the third set of one or more data representations available to the third calling entity.

16. The one or more storage media of claim 14, wherein:
the plurality of DR generators correspond to a plurality of input modality types that include two or more modality types in a set consisting of text, document, image, video, audio, time series, and tabular;
the first input data is a text string, a document, an image file, a video file, an audio file, times series data, or tabular data.

17. The one or more storage media of claim 13, wherein the first DR generation request includes an input modality type indicator that indicates a particular input modality type of the DR generator.

18. The one or more storage media of claim 13, wherein:
the first DR generation request includes storage location identification data that indicates where the first input data is stored;
retrieving the first input data comprises using the storage location identification data to retrieve the first input data.

19. The one or more storage media of claim 13, wherein the instructions, when executed by the one or more computing devices, further cause:
receiving a customization request from a third calling entity;
in response to receiving the customization request, updating a model of the DR generator to generate a customized version of the model;
in response to receiving a third DR generation request from the third calling entity:
retrieving third input data based on the third DR generation request;
generating, using the customized version of the model of the DR generator, based on the third input data, a third set of one or more data representations;
making the third set of one or more data representations available to the third calling entity.

20. The one or more storage media of claim 19, wherein:
the customization request includes storage location identification data that identifies a storage location where training data is stored;
the instructions, when executed by the one or more computing devices, further cause retrieving the training data from the storage location;
wherein updating the model comprises re-training the model based on the training data.
